(19) United States
(12) Patent Application Publication
(10) Pub. No.: US 2009/0231442 A1
(43) Pub. Date: Sep. 17, 2009

(54) PORTRAIT MEDIUM FOR ELECTRONIC APPLICATION, AND APPARATUSES FOR PRODUCING, INVALIDATING, AND REISSUING THE SAME

(76) Inventors: Makoto Yonaha, Kanagawa-ken (JP); Hajime Shirasaka, Kanagawa-ken (JP)

Correspondence Address: BIRCH STEWART KOLASCH & BIRCH, PO BOX 747, FALLS CHURCH, VA, 22040-0747, US

(21) Appl. No.: 12/090,802

(22) PCT Filed: Oct. 20, 2006
(86) PCT No.: PCT/JP2006/321447

§ 371 Date: Apr. 18, 2008

(30) Foreign Application Priority Data
Oct. 21, 2005 (JP) 2005-306872

(51) Int. Cl. H04N 5/225; G06K 9/62

(52) U.S. Cl. 348/207.2; 382/209; 348/E05.024

(57) ABSTRACT

To easily produce and/or invalidate a portrait medium without a special photographing admitting organization.

A photo booth is provided with a digital camera for taking the face, a means for outputting certification information representing that the portrait data is of a real image, means for recording information representing a valid period of the portrait data and a recording portion which records the portrait data and the certification information not to be falsified.

### TECHNICAL FIELD

This invention relates to a portrait medium for electronic application, and apparatuses for producing, invalidating and reissuing the same.

### BACKGROUND ART

Recently, there has been put into practice to take his or her certification portrait in a stand-alone photo booth to take his or her own portrait with ease to use it in various applications. The portrait of this type is printed on a photographic paper and is sometimes applied to the application paper and sometimes offered together with the application paper.

Recently, there have been made various trades over the Internet and various applications come to be able to be made over the Internet. For example, applications for public procedures or applications for entry into various membership clubs come to be able to be made over the Internet. For such applications, it is often required to offer the applicant's portrait. In order to meet such a requirement, to send data obtained by reading out a certification portrait with an image scanner or photographic data obtained by taking the portrait of him or her with a digital camera together with application data is conceivable to be effective.

However, a privately made photographic data can be processed by the use of various picture processing software and there is no certification that the data represents a real portrait without processing. Accordingly, it will be convenient if there is portrait data with certification which certifies that the data has not been processed.

As a method to meet this demand, there has been known a method of resisting falsification of certification portrait which this applicant has previously proposed (See, Japanese Unexamined Patent Publication No. 2003-244347).

In the method disclosed in Japanese Unexamined Patent Publication No. 2003-244347, image data obtained by taking the user by a photographing organization with a photographing means accepted by a photographing admitting organization is attached with attached information including photographing accepting information and photographing history information, and the image data attached with the attached information is stored in database and simultaneously transmitted to a user's personal computer by way of a network, and then the user transmits the image data from the user's personal computer to an image using organization. The image using organization receiving the transmission certificates the image, whether the image is obtained by really taking the user himself or herself and does not undergo a falsification. That is, an image determining means of the image using organization extracts the attached information from the image data and accesses the photographing organization by way of a network to collate the attached information with those stored in the database of the photographing organization, thereby certificating the image data.

The photographing admitting organization has a photographing acceptance issue means and a database and when the request for acceptance for photographing is made by way of a network, issues acceptance for photographing a certification portrait. When the acceptance for photographing a certification portrait is issued, photographing accepting information including information on photographing conditions, image making conditions such as to what range processing of the image is accepted, the period of acceptance and the like is attached. The issued photographing accepting information is stored in the database. The photographing admitting organization belongs to a third party which is separate from the photographing organization, user's personal computer or the image using organization, and certificates a certification portrait. The photographing admitting organization issues acceptance for photographing a certification portrait when the request for acceptance for photographing is made by way of a network by the photographing organization identifying the photographing means.

Accordingly, in accordance with the method of Japanese Unexamined Patent Publication No. 2003-244347, the photographing organization and the photographing admitting organization are necessary in addition to the user and when the certification portrait is to be certificated, the user must refer the certification portrait to the photographing organization.

However, it will be convenient if the certification portrait or the portrait medium for an electronic application can be made simply by the user as the stand-alone photo booth. Further, it is preferred that, in order to prevent a portrait medium from being used by others, for instance, when a portrait medium for electronic application is lost after being once made, the portrait medium be invalidated. Further, it is preferred to invalidate the portrait medium so that the user can easily invalidate the portrait medium while the others cannot invalidate the portrait medium and to reissue a valid portrait medium in response to invalidation thereof. Further, in view of the fact that the certification portrait generally must be taken within half a year since the face changes with time, it is preferred that a portrait medium has a predetermined valid period from photographing.

In order to meet such a demand, the primary object of the present invention is to provide a carrier carrying portrait data, that is, a portrait medium for electronic application, with a valid period and certification representing that the portrait data is not processed which can be easily obtained by a user without the photographing organization or the photographing admitting organization.

Another object of the present invention is to provide an apparatus for easily producing such a portrait medium.

Still another object of the present invention is to provide an apparatus in which a portrait medium once produced can be invalidated by himself or herself.

Yet still another object of the present invention is to provide an apparatus which reissues a new portrait medium.

### DISCLOSURE OF THE INVENTION

In accordance with the present invention, there is provided a portrait medium for electronic application characterized by having a computer readable medium in which portrait data of a person, certification information representing that the portrait data is of a real image of the person and information representing a valid period of the portrait data are recorded not to be falsified.

The expression “the portrait data is of a real image of the person” means that the portrait data has not been processed, and the certification information representing that the portrait data is of a real image of the person is information that the portrait has taken by a photographing means the data of which cannot be processed. The certification information may be a model number inherent to such a photographing means or may be a digital watermark which can be solely embedded by such a photographing means. Provided that the photographing means watches photographing and confirms that the photographing is regularly carried out, the certification information representing that the portrait data is of a real image of the person may be recorded by the photographing means. In the case where biometrics data such as a fingerprint of the person is obtained simultaneously with photographing a portrait of the person, information obtained by confirming that the face and the finger are of the same person may be included in the certification information.

The “valid period” means a term over which the medium is useful, and may be 6 months from the photographing as in general certification portraits since the face changes with time.

The expression “recorded not to be falsified” means to be recorded in a state of “read only” and, for instance, the information may be recorded on a read only recording medium (ROM). Though, to record the information not to be falsified can be realized by recording on a ROM, it can be realized also by recording an digital watermark together with the image. However, the latter is more convenient since the digital watermark can be used also as the certification information representing that the portrait data is of a real image of the person without processing or falsification.

In accordance with the present invention, there is further provided a portrait medium producing apparatus for producing a portrait medium for electronic application comprising a photographic camera which photographs a portrait of a person and outputs portrait data, a means for outputting certification information representing that the portrait data is of a real image, a means for outputting information representing a valid period of the portrait data and a recording means which records the portrait data, the certification information and the information representing a valid period of the portrait data on a computer readable recording medium not to be falsified.

In accordance with the present invention, there is further provided a portrait medium invalidating apparatus for invalidating a portrait medium for electronic application comprising a photographic camera which photographs a portrait of a person and outputs portrait data, and an invalidating means which collates portrait data taken and output by the photographic camera with the portrait data which have been photographed and recorded in the portrait media for electronic application made in the past or before the portrait data is taken by the photographic camera and invalidates the portrait medium for electronic application in which the portrait data conforming to the portrait data taken by the camera has been recorded.

In order to collates the portrait data photographed by the portrait medium invalidating apparatus with the past portrait data, it is necessary to access a database in which data of the portrait media made in the past have been stored. When one apparatus doubles the portrait medium invalidating apparatus and the portrait medium producing apparatus, the apparatus may be provided with the database. However, since actually it is preferred that a number of apparatuses be installed, preferably, the apparatuses can be communicated with one database by way of a network.

In accordance with the present invention, there is further provided a portrait medium reissuing apparatus for reissuing a portrait medium for electronic application comprising a photographic camera which photographs a portrait of a person and outputs portrait data, an invalidating means which collates portrait data taken and output by the photographic camera with the portrait data which have been photographed and recorded in the portrait media for electronic application made in the past or before the portrait data is taken by the photographic camera and invalidates the portrait medium for electronic application in which the portrait data conforming to the portrait data taken by the camera has been recorded, a reissue input means which instructs to issue a new portrait medium for electronic application on the basis of the portrait data photographed and output by the photographic camera, and a reissue means which issues a portrait medium for electronic application according to the instruction input by the reissue input means.

On the portrait medium of the present invention, as well as the face of a person, biometrics data such as the finger print, iris or the vein in the palm or the back of the hand of the person may be recorded not to be falsified. It is assumed here that the face of a person is not included in the biometrics data thereof.

The portrait represented by the portrait data may be printed on the surface of the portrait medium to be visually seen so that the person of the portrait medium or the person handling it can confirm on the spot of seeing it.

It is preferred that the apparatus for producing the portrait medium for electronic application be further provided with a means for recording on the portrait medium not to be falsified information for identifying the apparatus such as a serial number so that the apparatus by which the portrait is photographed and the portrait date is recorded can be known afterward. Further, the apparatus may be provided with a GPS and the information for identifying the apparatus may include information representing the place where the portrait medium producing apparatus is installed.

In accordance with the portrait medium for electronic application, since, in addition to the portrait data of a person, the certification information representing that the portrait data is of a real image of the person without processing and the information representing a valid period of the portrait data are recorded on a computer readable medium not to be falsified, the portrait medium can be used as the portrait data for electronic application as it is for a reception organization having a means for checking the certification information and the valid period information. Further, a system where the user can simply obtain a portrait medium for electronic application without the special photographing organization or the photographing admitting organization even in an unmanned photo booth can be constructed. Further, since the apparatus for reading the medium can easily recognize that a valid period of the portrait data has expired, it is possible to automatically make unuseful the portrait medium whose valid period has expired.

When biometrics data is recorded on the portrait medium in addition to his or her portrait, since the person can be confirmed by the biometrics data even if his or her face has changed, the application may be continued by the use of the biometrics data depending on the application or in the case where when a new portrait medium for electronic application is to be obtained (updated), a new portrait medium can be prepared by checking whether the person who requests a new portrait medium is the same one who posses the biometrics data by way of the biometrics data. When preparation (updating) of the new medium is to be made, the biometrics data which is kept unchanged may be transferred to the new medium as it is while only the portrait data have to be updated.

In accordance with the portrait medium invalidating apparatus for electronic application and the portrait medium reissuing apparatus for electronic application of the present invention, since the portrait data which has been photographed and output by the built-in photographic camera is collated with the portrait data which have been photographed and recorded in the portrait media for electronic application made in the past and the portrait medium for electronic application in which the portrait data conforming to the portrait data is invalidated, only the person who is photographed by the built-in photographic camera can invalidate the past portrait medium and reissue a new portrait medium in place of the portrait medium which, for instance, has been lost or stolen. Since even if the apparatuses are not directly connected to a memory means which stores all the data on the portrait medium for electronic application which are made in the past, the past portrait medium can be invalidated or reissued through a network, the apparatuses may be anywhere.

### BRIEF DESCRIPTION OF THE DRAWINGS

FIG. 1 is a side cross-sectional view showing in brief an example of the portrait medium producing apparatus,

FIG. 2 is a view showing in brief the controlling system of the portrait medium producing

FIG. 3 is a view showing an arrangement of the systems of the portrait medium invalidating apparatus or the portrait medium reissuing apparatus for electronic application of the present invention, and

FIG. 4 is a view showing an example of an apparatus for producing, invalidating and reissuing the portrait medium of the present invention.

### BEST MODE FOR CARRYING OUT THE INVENTION

Embodiments of the present invention will be described with reference to the drawings, hereinbelow.

A portrait medium producing apparatus

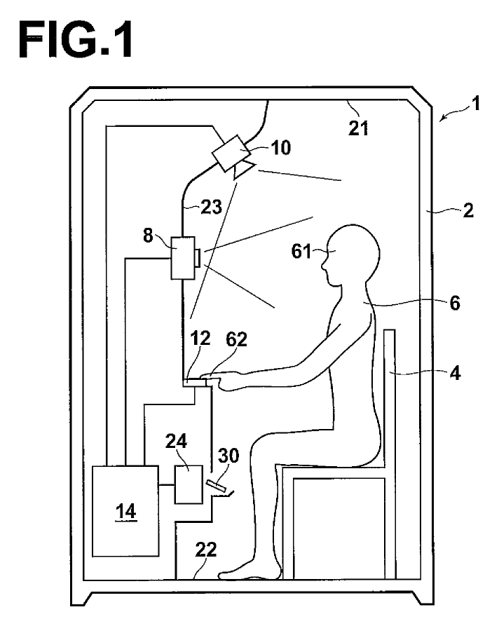

FIG. 1 is a side cross-sectional view showing the inside of a digital photo booth which is an example of a portrait medium producing apparatus in accordance with a present invention.

The digital photo booth comprises a chair 4 for photographing the user's face in a housing 2 which is in such a size that accommodates one person. In front of the chair 4, there is provided a partition wall 23 extending from a floor 22 to a ceiling 21. Though not shown in the drawings, preferably, the chair 4 is height adjustable. A digital camera 8 for photographing a face is fixed in a position opposed to the face 61 of a person 6 seated in the chair 4 in the partition wall 23, and a monitor camera 10 having wide-angle lens which simultaneously accommodates both the face 61 and the hands 62 of the person 6 in its field is fixed above the digital camera 8.

The digital camera 8 takes an image of the face 61 of the person 6 seated in the chair 4 and outputs portrait data, and the monitor camera 10 simultaneously watches the face 61 and the hand 62 of the seated person 6 and watches whether the irregular event, for instance, that another person invades the booth 2, and the face 61 of the seated person 6 is photographed while the hand of said another person is applied to the insufflator instead of the hand 61 of the seated person 6, takes place, and outputs a signal which certificates that the portrait data is regular, that is, the portrait data is of the same person as the owner of the fingerprint when it confirms that no irregularity takes place. In the determination of the irregularity in the watching, the irregularity can be recognized by the use of various kinds of image recognition software. Otherwise, a man may watch from a remote place to send a confirmation signal to the photo booth.

A certificate representing that the portrait taken by the digital camera 8 is a real image without processing is output by either the digital camera 8 or the monitor camera 10. This is information representing that the person has been photographed by the digital camera 8 where no processing is permitted and this is done by recording on the recording medium the certification data simultaneously with the image data taken by the digital camera 8. For example, this is done by a method in which the model number inherent to the digital camera 8 employed in the photographing is recorded on the recording medium together with the portrait data, or by embedding an digital watermark into the portrait data as will be described later.

An insufflator 12 is provided in the partition wall 23 in a position where the hand 62 of the seated person 6 can reach to get the fingerprint of the seated person 6.

The digital camera 8, monitor camera 10, and the insufflator 12 are electrically connected to a control unit 14 installed behind the partition wall 23 and the control unit 14 receives the output signal from each of these elements to execute the following processing.

The control unit 14 receives the signal from each of the digital camera 8, monitor camera and the insufflator 12 and processes the signals to make a portrait medium 30 for electronic application. In this embodiment, the control unit 14 comprises an abnormality determining means 16 which processes the signal from the monitor camera 10 and outputs certification information representing that there is no abnormality, a watermark engine is which embeds an digital watermark into the portrait data according to the output of the monitor camera 10, a synthesizing portion 20 which synthesizes the signals from the digital camera 8 and the insufflator 12 to generate a synthesized signal and embeds an digital watermark into the synthesized signal and a recording portion 24 which records the synthesized data on a recording medium to make a portrait medium 30 for electronic application.

The digital camera 8 which takes an image of the face and outputs portrait data has a built-in timer and records the date and time of photography linked with the portrait data. The date and time of photography functions as information representing the valid period of the portrait medium 30 made. For example, the portrait medium 30 is not useful after 6 months (valid period) expire therefrom. As method of making unuseful the portrait medium that, by recording a date and time 6 months after photography as a valid period, and the apparatus reading the portrait medium 30 determines whether the portrait medium 30 is valid through comparison of the time shown by its own built-in timer with the valid period.

The recording portion 24 is a recording means which records data with an digital watermark embedded at least one of the portrait data from the digital camera 9 and the fingerprint image data from the insufflator 12 on a computer readable recording medium such as a ROM and makes a portrait medium 30 for electronic application. The portrait medium 30 for electronic application thus made is discharged through a take-out port 26 provided in the partition wall 23.

The portrait medium 30 for electronic application may be an IC chip or a carrier of suitable size embedded with such an IC chip for the purpose of easiness to handle, or may be a memory of a size easy to handle. The portrait represented by the portrait data may be printed on the surface of the portrait medium 30 to be visually seen so that the person of the portrait medium or the person handling it can confirm on the spot of seeing it without confusion of a plurality of media.

Since the portrait medium 30 for electronic application thus made cannot be falsified after once made, the portrait medium 30 for electronic application can be used in various applications like a conventional certification portrait as a carrier carrying thereon real portrait data. Further, when downloaded in a personal computer, the portrait medium 30 for electronic application thus made can be attached to an electric mail to make an electronic application.

Further, since, on the portrait medium 30 for electronic application, personal information is not recorded and only the portrait data is recorded, the portrait medium 30 for electronic application can be used in services such as those where his or her face can be recognized but his or her personal information cannot be known. For example, when the service offering side has an apparatus for recognizing faces, and the portrait data is sent in advance to the service offering side such as a restaurant or a stadium, the service offering side can check the face to make admission without getting the customer's name or referring to the subscription list.

Further, since, on the portrait medium 30 for electronic application, personal information is not recorded and the personal information cannot escape even if it is lost, the portrait medium 30 is safe in view of the protection of the personal information. However, it is preferred that the portrait medium 30 for electronic application which has been lost be invalidated so that others cannot illegally use it. A portrait medium invalidating apparatus for invalidating a portrait medium for electronic application will be described, hereinbelow.

A portrait medium invalidating apparatus and a portrait medium reissuing apparatus

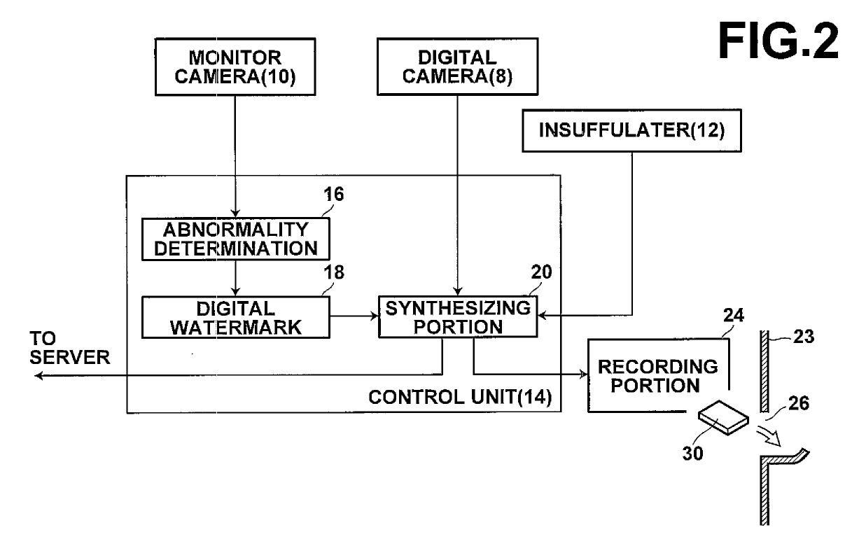

A portrait medium invalidating apparatus for invalidating a portrait medium for electronic application may be common with the photo booth of the portrait medium producing apparatus shown in FIG. 1 in hardware. However, since invalidation mostly takes place when the user has no medium which was produced in the past, it is necessary that data on the media which were produced in the past is stored in somewhere. Further, since invalidation means to make unuseful the medium when others intend to use the medium which he or she picked up, an apparatus which collates whether a medium is valid is necessary. Accordingly, though the portrait medium invalidating apparatus itself may be a photo booth, a server having a database to be collated is necessary in addition to the portrait medium invalidating apparatus. An example of such a server will be described with reference to FIGS. 2, 3 and 4, hereinbelow.

In order to actually realize the invalidation, it is necessary for the server to recognize whether the portrait data sent thereto for collation is the same as the invalidated data and to rapidly inform the sender of the result. For this purpose, it is preferred in view of the efficiency of the retrieval that, by attaching ID information to all the portrait data, whether the ID information of the portrait data sent thereto for collation is the same as that of the invalidated data be determined and the portrait data which is the same as the invalidated data in the ID information be informed to the sender. As such an ID information, for instance, the date and time of photography by the digital camera 8 can be employed.

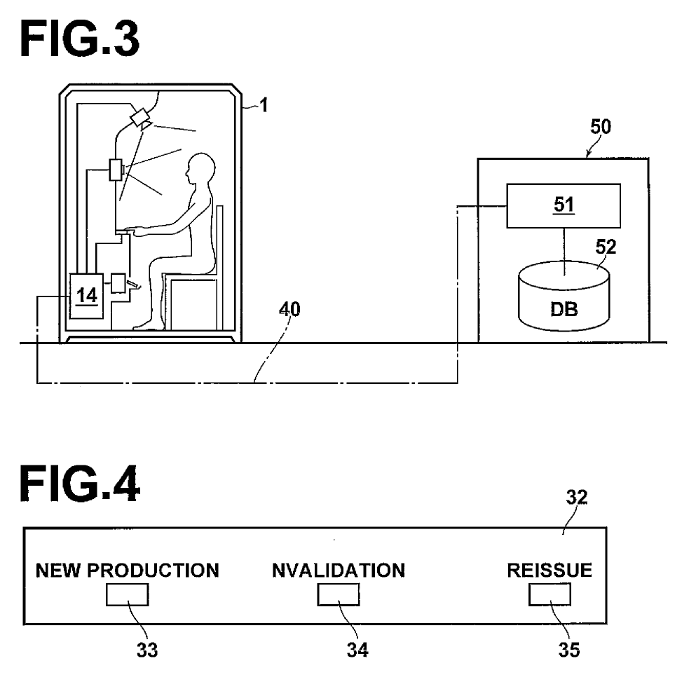

As shown in FIG. 3, the control unit 14 of the photo booth 1 forming the portrait medium invalidating apparatus is connected to a control station 50 by way of an optical fiber network 40 to be communicable with each other. The control station 50 has a server 51 provided with a database 52, and data for invalidation output from the synthesizing portion 20 of the control unit 14 of the photo booth 1 is sent to the server 51 in the control station 50 as shown in FIGS. 2 and 3. Though the data for invalidation may be data which is the same data as those recorded on the portrait medium 30 for electronic application and attached with the invalidation instruction, since the face changes and is relatively low in accuracy of collation, in order to simplify the collation of data, it is preferred that biometrics data which is more accurate and simpler than the face in collation be added to the portrait data, or to use the ID information for identifying the portrait media for electronic application made in the past, if exists. The in addition to a function of recording a new portrait data sent, has a function of retrieving a portrait data or the portrait date added with biometrics data, or the ID information from the data recorded in the database 52 and invalidating the corresponding portrait data. Further, the server 51 has a function of, when validness is collated, determining the validness thereof and informs the collator that the portrait medium is invalid when it is invalidated.

The photo booth 1 of the portrait medium invalidating apparatus is provided with an invalidation button 34 on a control panel 32 as shown in FIG. 4. In the photo booth 1 of the portrait medium reissuing apparatus is provided with a reissue button 35 in addition thereto. Since it is actually desired that the invalidation and the reissue can be controlled from the same photo booth, the control panel 32 of the photo booth 1 is provided with the invalidation button 34 and the reissue button 35 as well as a new production button 33.

When the invalidation button 34 is pressed, the face 61 is photographed as in production and the portrait data is sent to the server 51. The server 51 retrieves the portrait data conforming to the sent portrait data from a plurality of pieces of the portrait data stored in the database 52, and invalidates the portrait data. The portrait data which has as attached information a date and time before the data sent for invalidation is photographed is invalidated here.

Since, in order to invalidate the portrait medium, it is necessary, when a portrait is sent to collate the validity thereof, to inform the sender that the portrait medium is invalid, the correspondence of the portrait data sent for collation and a plurality of pieces of portrait data must be retrieved accurately. For this purpose, it is preferred in view of the accuracy and the efficiency that the sender be informed that the portrait medium is invalid on the basis of the ID information attached to the portrait data. Accordingly, it is preferred that ID information inherent to the portrait data be attached to the portrait data. As such ID information, though, the date and time of the photography of the portrait can be employed as described above, it is most preferred that such ID information be a combination of the date and time of the photography with information (a serial number) identifying the digital camera with which the photography has been carried out or identifying the photo booth in which the photography has been carried out since the portrait data cannot be distinguished from those simultaneously photographed in other photo booths. Otherwise, the ID information may be a combination of the date and time of the photography with information identifying the position of the photo booth. The information identifying the position of the photo booth may utilize the information data from a GPS provided in the photo booth.

Also the portrait medium reissuing apparatus may be common with the photo booth of the portrait medium producing apparatus shown in FIG. 1 in hardware. Reissue is a control which is done by a user when he or she invalidates a portrait medium, on which a portrait data has been recorded and whose valid period does not expire, due to loss or steal and when he or she wants a new portrait data which he or she can newly use. That the user receives a new portrait medium for electronic application when the valid period of the portrait medium for electronic application issued in the past expires is the same as new production and different from the reissue. When a portrait medium from electric application is newly made after the past portrait data is invalidated by operation of the portrait medium invalidating apparatus, a thing essentially the same as the reissue can be done. However, in the reissue, the past portrait can be used as it is. In this case, it is possible to make the system so that the photography need not be carried out again. However, in order to remove the necessity of taking the photograph again, it is necessary to use another means, e.g., biometrics data, to confirm the person. That is, the user who wants to reissue the portrait medium can be obtained a reissued valid portrait medium for electronic application by sending data of his or her fingerprint obtained in the photo booth to the control station to collate with the past fingerprint data, reading the portrait data corresponding to the past fingerprint data conforming to the sent fingerprint data, replacing the ID data attached to the portrait data with the ID data upon reissue, that is, the number of the photo booth where reissue is requested and the date and time of the request of reissue, and sending the data together with the portrait data to the photo booth.

Since the embodiment of the present invention described above is only an example for embodying the present invention, various embodiments other than that described above are possible. For example, the useful number of the portrait medium or the number by which the portrait medium can be used can be recorded instead of the valid period. In order to realize this, to record data representing that the useful number of the portrait medium is five in the portrait medium to be in use and to make unable access to the data the portrait medium used by five times. In this specification, the useful time should be included in the concept of the “valid period”.

The portrait medium of the present invention has a function of a certification picture exhibited upon various applications and can be used for various electronic applications. At the same time, the use of the portrait medium of the present invention, by registering the user's face to the service offering man when receiving a service to have the user's face mechanically memorized, to receive a better service when subsequently receiving a service taking into account the usage history can be conceived.

1-10. (canceled)

11. A portrait medium for electronic application, comprising a computer readable medium on which portrait data of a person, certification information representing that the portrait data is of a real image of the person and information representing a valid period of the portrait data are recorded not to be falsified.

12. A portrait medium for electronic application as defined in claim 11 in which the valid period is a predetermined period from recording the data and the information.

13. A portrait medium for electronic application as defined in claim 12 in which biometrics data other than the face of the person is further recorded on the computer readable medium not to be falsified.

14. A portrait medium for electronic application as defined in claim 13 in which a portrait represented by the portrait data is printed on a surface thereof.

15. A portrait medium producing apparatus for producing a portrait medium for electronic application comprising a photographic camera which photographs a portrait of a person and outputs portrait data, a means for outputting certification information representing that the portrait data is of a real image, a means for outputting information representing a valid period of the portrait data and a recording means which records the portrait data, the certification information and the information representing a valid period of the portrait data on a computer readable recording medium not to be falsified.

16. A portrait medium producing apparatus as defined in claim 15 further comprising a means for recording biometrics data of the person on the computer readable medium not to be falsified.

17. A portrait medium producing apparatus as defined in claim 16 further comprising a means for recording on the portrait medium not to be falsified information for identifying the portrait medium producing apparatus.

18. A portrait medium producing apparatus as defined in claim 17 in which the information for identifying the portrait medium producing apparatus includes information representing the place where the portrait medium producing apparatus is installed.

19. A portrait medium invalidating apparatus for invalidating a portrait medium for electronic application comprising a photographic camera which photographs a portrait of a person and outputs portrait data, and an invalidating means which collates portrait data taken and output by the photographic camera, portrait data taken and output by the photographic camera added with biometrics data or information identifying the portrait medium made in the past with the portrait data which have been photographed and recorded in the portrait media for electronic application made in the past, the portrait data which have been photographed and recorded in the portrait media for electronic application made in the past and is added with biometrics data or information identifying the portrait medium made in the past and invalidates the portrait medium for electronic application in which the portrait data conforming to the portrait data taken by the camera has been recorded.

20. A portrait medium reissuing apparatus for reissuing a portrait medium for electronic application comprising a photographic camera which photographs a portrait of a person and outputs portrait data, an invalidating means which collates portrait data taken and output by the photographic camera, portrait data taken and output by the photographic camera added with biometrics data or information identifying the portrait medium made in the past with the portrait data which have been photographed and recorded in the portrait media for electronic application made in the past, the portrait data which have been photographed and recorded in the portrait media for electronic application made in the past and is added with biometrics data or information identifying the portrait medium made in the past and invalidates the portrait medium for electronic application in which the portrait data conforming to the portrait data taken by the camera has been recorded, a reissue input means which instructs to issue a new portrait medium for electronic application on the basis of the portrait data photographed and output by the photographic camera, and a reissue means which issues a portrait medium for electronic application according to the instruction input by the reissue input means.
